(19) United States
(12) Patent Application Publication
(10) Pub. No.: US 2018/0139923 A1
(43) Pub. Date: May 24, 2018

(54) MULTIPLE ANIMAL CAGE SYSTEM

(71) Applicants: Jasmine Williams, Rochester, NY (US); Humberto Ortiz, Rochester, NY (US)

(72) Inventors: Jasmine Williams, Rochester, NY (US); Humberto Ortiz, Rochester, NY (US)

(21) Appl. No.: 15/820,861

(22) Filed: Nov. 22, 2017

Related U.S. Application Data
(60) Provisional application No. 62/426,194, filed on Nov. 23, 2016.

(51) Int. Cl. A01K 1/03; A01K 31/06

(52) U.S. Cl. CPC A01K 1/03; A01K 31/06

(57) ABSTRACT

A multiple animal cage system is a two tiered animal cage adapted to house at least one animal in each cage. The cages are designed so that animals of different species or animals of the same species can be caged. The cage has an upper cage portion and a lower cage portion and each cage portion has a front access door and a slide-out tray in the bottom that catches animal droppings. The cage is mounted onto wheels for easy portability.

### CROSS-REFERENCE TO RELATED APPLICATION

The present application is related to and claims priority from prior provisional application Ser. No. 62/426,194, filed Nov. 23, 2016 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of cages and more specifically relates to a multiple animal cage system.

### 2. Description of the Related Art

Cages are enclosures that are most often made of wire mesh or metal bars that are used to confine, contain, or protect something or someone. The most common use is for confining wild or domesticated animals. Cages can provide a comfortable habitat for the animal, reptile, or bird, and are most often designed specifically for the needs of the particular species of animal or bird confined in the cage. Cages used for dogs or cats are most often referred to as kennels and the sizes of kennels made are as varied as the particular species of pet confined, ranging from small plastic purse size kennels to large dog breed size kennels made of wire mesh or metal bars.

It is not uncommon to have multiple species of pets within one family. This is more common when the size of the family is larger than average or has more children than the average size family. This is not always the case though. Some households of only one person often have two or more pets to alleviate the loneliness of solitary living. The cages or kennels tend to take up valuable space in the average sized home and having a plurality of pets can take up space that is needed by the human inhabitants. A solution that will allow the combining of the habitats of multiple animals or of a plurality of species of animals is needed to optimize the available space.

Various attempts have been made to solve the above-mentioned problems such as those found in U.S. Pat. No. 4,104,986 to Opal Dunigan; U.S. Pat. No. 7,343,876 to Linda Susan Frisbee; U.S. Publication No. 2007/0227460 to John P. Lynch; U.S. Pat. No. 7,487,744 to Goldberg et al.; and U.S. Pat. No. 7,059,274 to Kuo-Ho Cheng. None of the above inventions and patents, taken either singly or in combination, is seen to describe the invention as claimed.

Ideally, an animal cage should provide habitats for multiple animals or multiple species of animals within the same cage, and yet, would operate reliably and be manufactured at a modest expense. Thus, a need exists for a reliable multiple animal cage system to avoid the above-mentioned problems.

### BRIEF SUMMARY OF THE INVENTION

In view of the foregoing disadvantages inherent in the known cage art, the present invention provides a novel multiple animal cage system. The general purpose of the present invention, which will be described subsequently in greater detail, is to provide habitats for multiple animals or multiple species of animals within the same cage.

The multiple animal cage system preferably comprises a top cage portion having a top grating formed from a series of interconnected bars, a bottom grating formed from a series of interconnected bars, and at least one side grating that includes at least one movable access door member formed from a series of interconnected bars. The side gratings are connected between the top grating and the bottom grating, and the top grating, the bottom grating, and the side gratings define a first interior volume for housing an animal therein. A center section having a removable tray member is adapted to catch and retain animal droppings thereupon that fall through the bottom grating. The center section is connected to the side gratings of the top cage portion and located underneath the bottom grating of the top cage portion.

A bottom cage portion having a bottom section including a removable drawer member is adapted to removably retain a cushion member thereon for an animal to rest upon. The side gratings of the bottom cage portion include at least one removable access door member that is formed from a series of interconnected bars. The side grating(s) are connected between the bottom section of the bottom cage portion and the center section. The side gratings, the bottom section, and the center section define a second interior volume for housing an animal therein.

The multiple animal cage system is adapted to house at least two animals at the same time and to separate chosen animals between the top cage portion and the bottom cage portion. The center section includes a bottom wall member connected to a bottom section of the side grating of the top cage portion and is adapted to slidably support the removable tray member. The bottom section of the bottom cage portion includes a bottom wall member connected to the bottom section of the side grating of the bottom cage portion and adapted to slidably support the removable drawer member. At least two spaced wheel members are connected to the bottom section of the side grating of the bottom cage portion.

A cushion member is adapted to be removably placed upon the removable drawer member for an animal to rest upon. The side grating of the top cage portion may include three spaced movable access door members. The side grating of the bottom cage portion includes one movable access door member.

The side grating of the top cage portion includes a climbing barrier attached to a top portion thereof adapted to prevent an animal from climbing onto the top grating. The climbing barrier preferably extends along the side grating for at least three inches. The side grating of the top cage portion includes a gutter shield attached to the lower portion thereof adapted to prevent material from falling from the top cage portion and it extends outwardly from the side grating at least two inches therefrom.

A plurality of bird accessories and toys are adapted to be removably hung from the top grating of the top cage portion. The removable tray member includes at least one handle member thereon and the removable drawer member includes at least one handle member thereon. The series of interconnected bars of the top and bottom cage portions are formed from a material chosen from the group of materials consisting of steel, aluminum, plastic, and ceramic.

The top and bottom cage portions preferably have a pentagonal cross section. The movable access door members of the top and bottom cage portions are respectively pivotally attached thereto and include a releasable locking member thereon for releasably locking each movable access door member into a closed position. The at least two spaced wheel members each include a releasable locking member thereon adapted to prevent rotating motion of the wheel members and thereby unwanted movement of the multiple animal cage system.

The present invention holds significant improvements and serves as a multiple animal cage system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, multiple animal cage system constructed and operative according to the teachings of the present invention.

FIG. 1 shows a perspective view illustrating a multiple animal cage system according to an embodiment of the present invention.

FIG. 2 is a second perspective view illustrating a multiple animal cage system according to an embodiment of the present invention of FIG. 1.

FIG. 3 is a perspective view illustrating the removable tray member and removable drawer member removed from the multiple animal cage system according to an embodiment of the present invention of FIG. 1.

The various embodiments of the present invention will hereinafter be described in conjunction with the appended drawings, wherein like designations denote like elements.

### DETAILED DESCRIPTION

As discussed above, embodiments of the present invention relate to a cage and more particularly to a multiple animal cage system as used to improve the optimizing of space by combining multiple species habitats in a single cage system.

Generally speaking, the multiple animal cage system is a two tiered animal cage adapted to house at least one animal in each cage. The cages are designed so that animals of different species or animals of the same species can be caged. The cage has an upper cage portion and a lower cage portion and each cage portion has a front access door and a slide-out tray in the bottom that catches animal droppings. The cage is mounted onto wheels for easy portability.

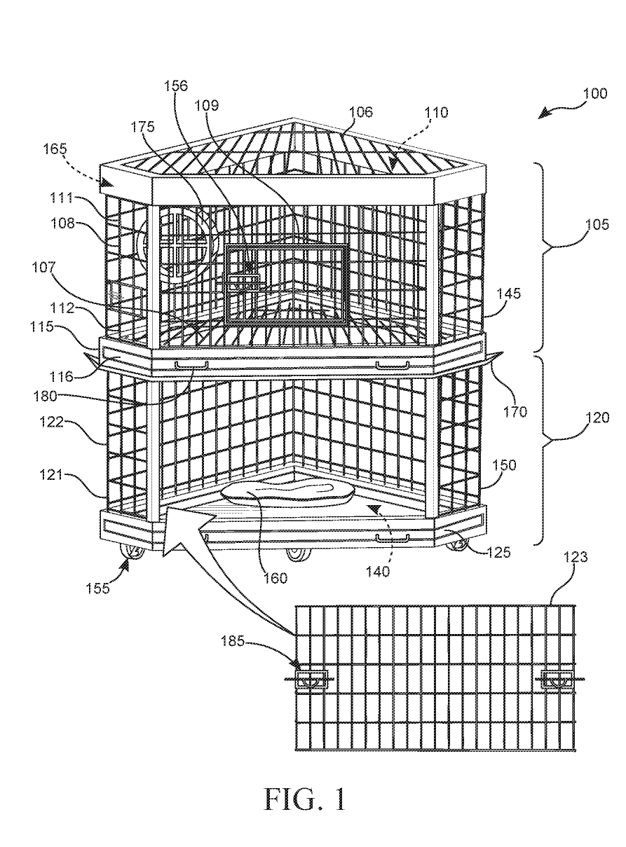

Referring to the drawings by numerals of reference there is shown in FIG. 1, is a perspective view illustrating multiple animal cage system 100 according to an embodiment of the present invention.

Multiple animal cage system 100 is adapted to house at least two animals at the same time and to separate chosen animals between top cage portion 105 and bottom cage portion 120. Multiple animal cage system 100 preferably comprises top cage portion 105 having top grating 106 formed from a series of interconnected bars, bottom grating 107 formed from a series of interconnected bars, and at least one side grating 108 that includes at least one movable access door member 109 formed from a series of interconnected bars. Side gratings 108 and 122 are connected between top grating 106 and bottom grating 107, and top grating 106, bottom grating 107, and side grating 108 define first interior volume 110 for housing an animal therein. Center section 115 having removable tray member 116 is adapted to catch and retain animal droppings thereupon that fall through bottom grating 107. Center section 115 is connected to side grating 108 of top cage portion 105 and located underneath bottom grating 107 of top cage portion 105.

Bottom cage portion 120 having bottom section 121 including removable drawer member 125 is adapted to removably retain cushion member 160 thereon for an animal to rest upon. Side grating 122 of bottom cage portion 120 includes at least one removable access door member 123 that is formed from a series of interconnected bars. Side grating 122 is connected between bottom section 121 of bottom cage portion 120 and center section 115. Side grating 122, bottom section 121, and center section 115 define second interior volume 140 for housing an animal therein.

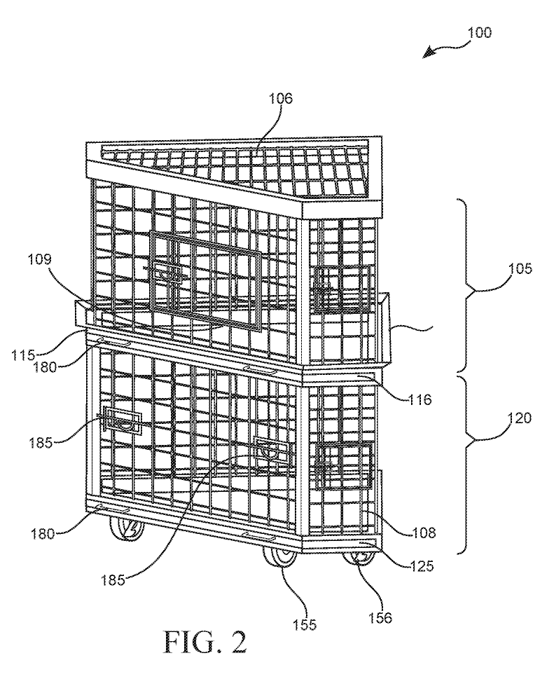

Referring now to FIG. 2, is a second perspective view illustrating multiple animal cage system 100 according to an embodiment of the present invention of FIG. 1.

Side grating 108 of top cage portion 105 may include as many as three spaced movable access door members 109 but will include at least one movable access door member 109 in any embodiment.

Side grating 108 of top cage portion 105 includes climbing barrier 165 attached to top portion 111 thereof adapted to prevent an animal from climbing onto top grating 106. The climbing barrier preferably extends alongside grating 108 for at least three inches. Side grating 108 of top cage portion 105 includes gutter shield 170 attached to lower portion 112 thereof adapted to prevent material from falling from top cage portion 105 and it extends outwardly from side grating 108 at least two inches therefrom.

A plurality of bird accessories and toys 175 are adapted to be removably hung from top grating 106 of top cage portion 105. Removable tray member 116 includes at least one handle member 180 thereon and removable drawer member 125 includes at least one handle member 180 thereon. The series of interconnected bars of the top 105 and bottom cage portions 120 are formed from a material chosen from the group of materials consisting of steel, aluminum, plastic, and ceramic.

The top 105 and bottom cage portions 120 preferably have a pentagonal cross section. Movable access door members 109 of the top 105 and removable access door member 123 of bottom cage portion 120 are respectively pivotally attached thereto and include releasable locking member 185 thereon for releasably locking each into a closed position.

At least two, and preferably three spaced wheel members 155 support multiple animal cage system 100 for easy portability and each spaced wheel member 155 includes releasable locking member 156 thereon adapted to prevent rotating motion of spaced wheel members 155 and thereby unwanted movement of multiple animal cage system 100.

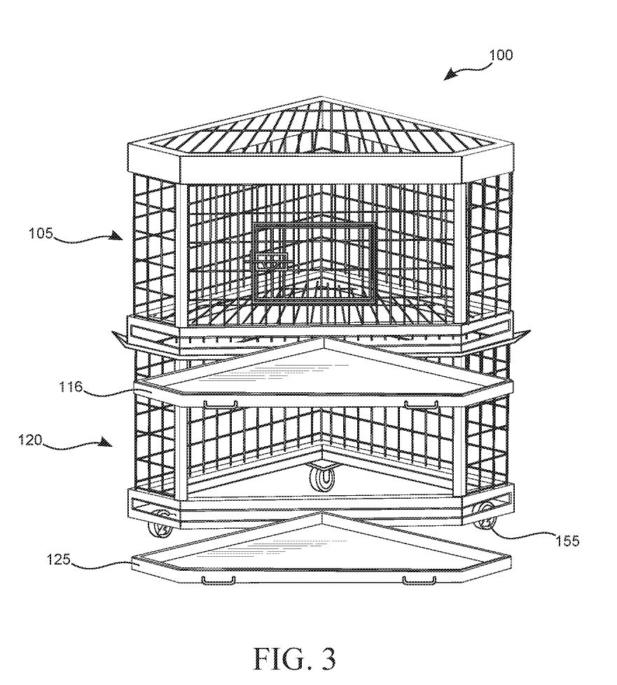

Referring now to FIG. 3, is a perspective view illustrating removable tray member 116 and removable drawer member removed from multiple animal cage system 100 according to an embodiment of the present invention of FIG. 1.

Center section 115 includes bottom wall member 145 connected to bottom section 121 of side grating 108 of top cage portion 105 and is adapted to slidably support removable tray member 116. Bottom section 121 of bottom cage portion 120 includes bottom wall member 150 connected bottom section 121 of side grating 122 of bottom cage portion 120 and adapted to slidably support removable drawer member 125. Cushion member 160 is adapted to be removably placed upon removable drawer member 125 for an animal to rest upon.

Multiple animal cage system 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other contents or arrangements such as, for example, including more or less components, customized parts, different color combinations, parts may be sold separately, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is:

1. A multiple animal cage system comprising:
a top cage portion including:
a top grating;
wherein said top grating is formed from a series of interconnected bars;
a bottom grating;
wherein said bottom grating is formed from a series of interconnected bars;
at least one side grating including:
at least one movable access door member;
wherein said at least one side grating is formed from a series of interconnected bars;
wherein said at least one side grating is connected between said top grating and said bottom grating; and
wherein said top grating, said bottom grating, and said at least one side grating define a first interior volume for housing an animal therein;
a center section including:
a removable tray member;
wherein said removable tray member is adapted to catch and
retain animal droppings thereupon that fall through said bottom grating;
wherein said center section is connected to said at least one side grating of said top cage portion and located underneath said bottom grating of said top cage portion; and
a bottom cage portion including:
a bottom section including:
a removable drawer member;
wherein said removable drawer member is adapted to
removably retain a cushion member thereon for an animal to rest upon;
at least one side grating including:
at least one removable access door member;
wherein said at least one side grating is formed from a series of interconnected bars;
wherein said at least one side grating is connected between said bottom section of said bottom cage portion and said center section; and
wherein said at least one side grating, said bottom section, and
said center section define a second interior volume for housing an animal therein;
wherein said multiple animal cage system is adapted to house at least two animals at the same time; and
wherein said multiple animal cage system is adapted to separate chosen ones of said at least two animals between said top cage portion and said bottom cage portion.

2. The multiple animal cage system of claim 1, wherein said center section includes a bottom wall member connected to a bottom section of said at least one side grating of said top cage portion and is adapted to slidably support said removable tray member.

3. The multiple animal cage system of claim 1, wherein said bottom section of said bottom cage portion includes a bottom wall member connected to a bottom section of said at least one side grating of said bottom cage portion and adapted to slidably support said removable drawer member.

4. The multiple animal cage system of claim 1, further comprising at least two spaced wheel members connected to a bottom section of said at least one side grating of said bottom cage portion.

5. The multiple animal cage system of claim 1, further comprising a cushion member adapted to be removably placed upon said removable drawer member for an animal to rest upon.

6. The multiple animal cage system of claim 1, wherein said at least one side grating of said top cage portion includes three spaced movable access door members.

7. The multiple animal cage system of claim 6, wherein said at least one side grating of said bottom cage portion includes one movable access door member.

8. The multiple animal cage system of claim 1, wherein said at least one side grating of said top cage portion includes a climbing barrier attached to a top portion thereof adapted to prevent an animal from climbing onto said top grating; and wherein said climbing barrier extends along said at least one side grating for at least three inches.

9. The multiple animal cage system of claim 1, wherein said at least one side grating of said top cage portion includes a gutter shield attached to a lower portion thereof adapted to prevent material from falling from said top cage portion; and wherein said gutter shield extends outwardly from said at least one side grating at least two inches therefrom.

10. The multiple animal cage system of claim 1, further comprising a plurality of bird accessories and toys adapted to be removably hung from said top grating of said top cage portion.

11. The multiple animal cage system of claim 1, wherein said removable tray member includes at least one handle member thereon.

12. The multiple animal cage system of claim 1, wherein said removable drawer member includes at least one handle member thereon.

13. The multiple animal cage system of claim 1, wherein said series of interconnected bars of said top and bottom cage portions are formed from a material chosen from a group of materials consisting of steel, aluminum, plastic, and ceramic.

14. The multiple animal cage system of claim 1, wherein said top and bottom cage portions have a pentagonal cross section.

15. The multiple animal cage system of claim 7, wherein said movable access door members of said top and bottom cage portions are respectively pivotally attached thereto; and wherein each said movable access door members includes a releasable locking member thereon for releasably locking each said movable access door member in a closed position.

16. The multiple animal cage system of claim 4, wherein said at least two spaced wheel members each include a releasable locking member thereon adapted to prevent rotating motion of said wheel members and thereby unwanted movement of said multiple animal cage system.
